(19) United States
(12) Patent Application Publication
(10) Pub. No.: US 2009/0071941 A1
(43) Pub. Date: Mar. 19, 2009

(54) Method for laser etching and/or laser embossing and powder coating a substrate

(76) Inventors: Michael F. Knoblauch, Cleveland Heights, OH (US); William Miller, Rocky River, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 12/218,344

(22) Filed: Jul. 14, 2008

Related U.S. Application Data
(60) Provisional application No. 60/993,798, filed on Sep. 14, 2007.

(51) Int. Cl. B44C 1/22; B05D 3/06

(52) U.S. Cl. 216/94; 427/555

(57) ABSTRACT

A method for finishing a substrate including transferring an image onto the substrate and powder coating the substrate. Embodiments provide methods for producing simulated wood grain finishes on engineered wood products such as medium density fiberboard. Logos, graphics, text, and the like may be embossed and/or etched onto the substrate using a laser. In alternative embodiments, the substrate may comprise a solid polymer.

### CROSS-REFERENCE TO RELATED APPLICATION

This application claims the benefit of U.S. Provisional Application No. 60/993,798, filed Sep. 14, 2007, which is hereby incorporated by reference in its entirety.

### BACKGROUND OF THE INVENTION

This invention relates generally to the field of powder coat surface finishing and, in particular, the powder coating of engineered wood products. More particularly, the invention relates to laser etching and/or embossing a fiberboard substrate and coating the substrate with a powder coat finish.

### BRIEF SUMMARY OF THE INVENTION

Embodiments of the present invention provide a method for finishing a substrate including transferring an image onto the substrate and powder coating the substrate. Embodiments provide methods for producing simulated wood grain finishes on engineered wood products such as medium density fiberboard. Logos, graphics,patterns, text, and the like may be embossed and/or etched onto the substrate using a laser. In alternative embodiments, the substrate may comprise a solid polymer.

In a first aspect, an exemplary method according to the present invention may include the steps of transferring a first image onto a substrate using laser embossing and/or laser etching, coating the substrate with a powder coating, and curing the powder coating. The method may further include a step of transferring a second image onto the substrate using laser embossing and/or laser etching. The first image may include wood grain. The first image may include a graphic, pattern, design, logo, character, text, likeness, picture, and/or texture. The first image may include wood grain and the second image may include a graphic, design, logo, character, text, likeness, and/or picture. The substrate may include an engineered wood product such as, but not limited to, medium density fiberboard. The substrate may include a solid polymer. The powder coating may include a resin based powder coating that cures to be substantially transparent. The powder coating may include an ultra-violet light curable powder coat and the curing step may use ultra-violet light to cure the powder coat. The powder coat may include a thermosetting powder coat composition and the curing step may use heat to cure the powder coat.

In a second aspect, an exemplary method according to the present invention may include the steps of providing a substrate including medium density fiberboard; transferring a first image including a wood grain onto the substrate using laser embossing and/or laser etching; preheating the substrate; electro-static powder coating the substrate with a powder coat; heating the substrate to cause the powder coat to gel and/or flow; and curing the powder coat using ultra-violet light. The method may further include the step of, prior to the powder coating step, transferring a second image onto the substrate using laser embossing and/or laser etching. The second image may include a graphic, pattern, design, logo, character, text, likeness, and/or picture. The method may further include the steps of manipulating the first image and manipulating the second image, prior to the transferring steps, wherein the manipulating steps include cropping, rotating, resizing, and/or copying. The first image and the second image may be transferred onto a first surface of the substrate and a second surface of the substrate, respectively. The powder coat may be a resin based powder coat that cures to be substantially transparent. The powder coat may be a resin based powder coat that cures to be substantially transparent, tinted or pigmented to be opaque.

In a third aspect, an exemplary method according to the present invention may include the steps of providing a substrate including medium density fiberboard; transferring a first image including a wood grain onto the substrate using laser embossing and/or laser etching; transferring a second image including a graphic, pattern, design, logo, character, text, likeness, and/or picture onto the substrate using at least one of a laser embossing and laser etching; preheating the substrate; electro-static powder coating the substrate with a powder coat; heating the substrate to cause the powder coat to at least one of gel and flow; and curing the powder coat. The curing step may be an ultra-violet curing step and/or a thermal curing step. The preheating step may use both infra-red energy and convection. The method may further include the step of conveying the substrate through the preheating, powder coating and/or curing steps on a conveyor system. The curing step may be a combination of at least thermal curing and ultra-violet curing.

In a fourth aspect, an exemplary method according to the present invention may include the steps of providing a substrate including medium density fiberboard; transferring a first image including a wood grain onto the substrate; preheating the substrate; electro-static powder coating the substrate with a powder coat; heating the substrate to cause the powder coat to gel and/or flow; and curing the powder coat thereby creating a product with a simulated wood grain finish.

### BRIEF DESCRIPTION OF THE SEVERAL VIEWS OF THE DRAWING

The detailed description particularly refers to the accompanying Figures in which:

FIG. 1 is a flowchart of an exemplary process according to the present invention;

FIG. 2 is a schematic representation of an exemplary powder coating process according to the present invention; and

FIG. 3 is a depicts a product of an exemplary process according to the present invention.

### DETAILED DESCRIPTION OF THE INVENTION

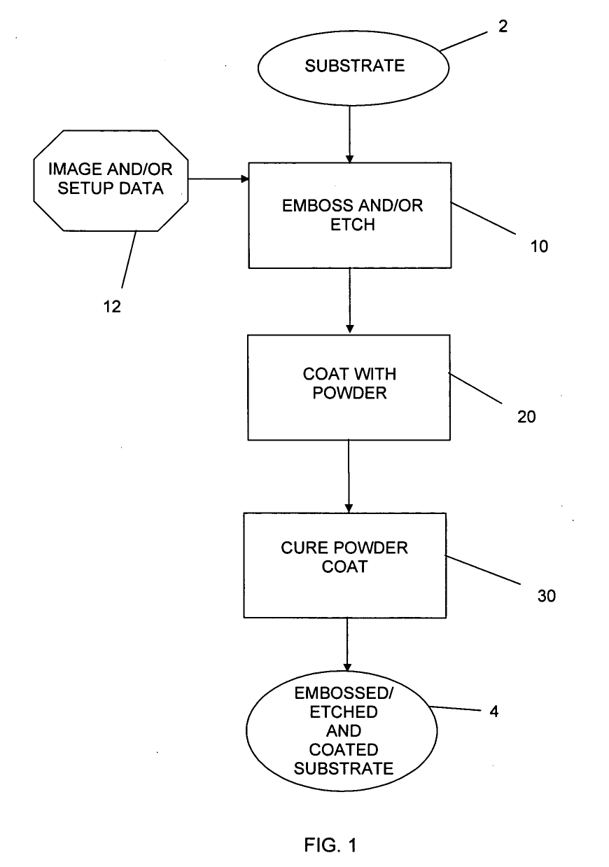

As depicted in FIG. 1, an exemplary process comprises three primary steps performed on a substrate 2. First, the substrate 2 is embossed and/or etched in step 10. Second, a powder coat is applied in step 20. Third, the powder coat is cured in step 30, producing a product comprising an embossed and/or etched and powder coated substrate 4.

The first primary step 10 in the exemplary process is embossing and/or etching a substrate 2. As user herein, embossing generally refers to changing the relative levels of the surface of an object to create a raised effect and etching generally refers to producing an image on an object, usually a hard surface, by eating into the object's surface. As used herein, image generally refers to any graphic, pattern, design, logo, character, text, likeness, picture, texture, or any other alteration of a surface. Further, as used herein, image may refer to one or more images and may refer to a combination of separate or overlapping images as defined above. The embossing and/or etching may result in areas of varying depth across the substrate such that a three dimensional effect is achieved.

The substrate 2 may comprise any object or medium capable of being embossed and/or etched and powder-coated. In the exemplary process, the substrate comprises medium density fiberboard (“MDF”). MDF is an engineered wood product made from compressed and bonded wood fibers. MDF is usually very dense and is dimensionally stable, thus allowing for very fine tolerances when machined. MDF is often used as a substrate for sheet goods, doors, cabinets, and furniture, among other uses. The substrate may also comprise another wood product such as, but not limited to, a laminated wood product and or another engineered wood product. Further, the substrate may be unfinished or may be partially or fully prefinished.

The substrate may also comprise a solid polymer such as, but not limited to, molded plastic. If the substrate comprises a material such as molded plastic that has a relatively low melting temperature, the oven settings for the preheat and gel/flow steps, discussed below, may be adjusted to accommodate the temperature ratings of the substrate material. More generally, the oven settings may be adjusted to accommodate any temperature-dependent characteristics of a substrate.

In the exemplary process, a laser is used to emboss and/or etch the image onto the substrate. Prior to embossing and/or etching substrates, the digital image to be embossed and/or etched is obtained and prepared. An image may be obtained by scanning, copying, photographing, drawing, importing, or by any other means of acquiring a digital image. One or more images may be combined to form a single image.

Image processing software (such as, but not limited to, ADOBE PHOTOSHOP) may be used to manipulate the image. For example, the image processing software may be used to enhance the image by changing, adding, or removing pixels to optimize the look of the image. The image may be resized or copied as necessary to appropriately size the image for embossing and/or etching onto a particular substrate of a particular size and/ or shape. The image may be converted to a grayscale image and saved in a particular file format. In the exemplary process, the image is saved in a grayscale tagged image file format (“TIFF”) and exported from the image manipulation software.

The image file may be further manipulated using software adapted to prepare an image file for use as an input to an embossing and/or etching operation. In the exemplary process, TECHNOBLAST II software may be used to make final design modifications and to confirm an appropriate pixels per inch ratio (1 inch=40 pixels, for example). In addition, line intensities, drawing direction, X and Y axis directions may be adjusted as desired. In the exemplary process, the TECHNOBLAST II software saves the image file in “Technoblast Format” (“TBF”).

In the exemplary process, the TBF file is imported into LasX laser control software. The laser control software may permit burn adjustments including variation of speed and power. A dry burn may be done to produce a template for the placement of the substrate. One or more test burns may be performed on substrates to allow testing and adjustment of burn parameters to achieve optimal image embossing and/or etching.

See U.S. Pat. Nos. 5,590,444, 5,916,461, 6,002,099, 6,140,602, 6,252,196, 6,315,202, 6,495,237, 6,576,862, 6,664,505, 6,753,501, 6,807,456, 6,819,972, 6,850,812, and 7,318,377 and U.S. Patent Application Publication Nos. 2001/0025835 and 2007/0084835, each of which is hereby incorporated by reference in its entirety.

In the exemplary process, different file formats may be used if the image comprises a vector image. For example, the image may be saved as a “drawing interchange file” (“DXF”), also known as a “drawing exchange file,” or a “drawing” (“DWG”) file. By saving the image in such a format, the laser control system may recognize the image as one requiring a vector burn. The DXF or DWG file may be imported into the LasX laser control software in a manner similar to the TBF file described above.

Production of embossed and/or etched substrates may begin after the image preparation and laser setup are complete. In the exemplary process, the image preparation and laser setup are only necessary when a different image or substrate are used. In FIG. 1, the prepared image and laser setup data are represented as data 12, shown as an input to the embossing and/or etching step 10. Multiple substrates may be embossed and/or etched without repeating the image preparation and laser setup. Some preparation of the substrate (such as, but not limited to cutting, sanding, and machining) may be performed prior to embossing and/or etching and/or powder coating. In the exemplary process, the substrate requires little or no sanding.

It is within the scope of the invention to utilize more than one embossing and/or etching device. It is also within the scope of the invention to emboss and/or etch more than one surface or portion of the substrate. Further, it is within the scope of the invention to perform more than one embossing and/or etching operation on each substrate or a portion thereof.

The second primary step 20 in the exemplary process is powder-coating the embossed and/or etched substrate. The powder-coating step may include several sub-steps. In the exemplary process, the powder-coating step includes preheating, coating, and a gel/flow step (also known as melting and flowing).

In the exemplary process, the substrate is preheated in an oven prior to being coated with powder. The preheating step is intended to enable each substrate to have the same heat profile and to facilitate an even and consistent electrostatic charge, thus ensuring a constant amount of powder is deposited on each substrate. In the exemplary process, the preheat oven is a Nutro Coyote Hybrid IR/Convection oven. This oven preheats the substrate using both infra red (“IR”) energy and convection. The preheat oven has three portions: a left side IR portion, a convection portion, and a right side IR portion. In the exemplary process, the settings are 450 F for the left side IR portion, 400 F for the convection portion, and 450 F for the right side IR portion. The IR portions may have ranges of 400 F to 600 F in certain embodiments. In the exemplary process, the preheat time is 1 minute.

In the exemplary process, the substrate is coated with powder following the preheat step. The exemplary process utilizes an electro-static powder coating paint system. In the exemplary process, powder is applied in a Nordson Excel 2000 powder coating booth using 14 Versaspray II automatic powder spray guns, with 7 guns on each side. The spray system includes two oscillators. It is within the scope of the invention to utilize one or more hand sprayers instead of or in addition to one or more automatic sprayers.

In the exemplary process, the powder coating system allows manual control of “flow” and “atomizing” settings. The “flow” setting affects the amount of powder being delivered and the “atomizing” setting affects breaking up of the powder and smoothness of the pattern. Normally the flow may be set at 14 and atomizing air may be set at 25. Normally the voltage may be set at 100 kV, though this setting may be adjusted if, for example, the substrate is being recoated or if it has Faraday areas.

The exemplary coating step achieves an average coating thickness of 3.5 mils. Various embodiments range between 2-5 mils. The acceptable thickness may vary with the particular coating and substrate materials as well as the desired finish. It is within the scope of the invention to apply a powder coat with a thickness outside of this specified range.

In the exemplary process, the powder coating gun provides a negative 100 kV to charge the powder. The substrate, MDF in the exemplary process, is heated by convection and IR portions of the preheat oven to bring moisture to the surface which allows the substrate to become conductive. Since the substrate is more positive and the charge of the powder is negative, the powder is attracted to the substrate.

In the exemplary process, the powder coated substrate is conveyed to a gel/flow oven. In the exemplary process, the gel/flow step occurs in the same type of oven as is used for the preheat step. In the exemplary process, the gel/flow oven operates with the left and right IR portions at 500 F and the convection portion at 400 F.

The third primary step 30 of the exemplary process is curing the powder coat. The exemplary process cures the powder coat with ultra violet (“UV”) light using a Fusion F600S UV light system. This system includes 14 lamps: 6 left, 6 right, 1 top, and 1 bottom. The full power rating of the lamps is 600 W per inch for a total of 6000 W. At low power, the lamps emit 400 W per inch for a total of 4000 W. The bulbs emit wavelengths in the range of 405-440 nm. The lamps are “V” type lamps. In the exemplary process, the lamps are normally operated at the low power setting and the lamps receive power from Fusion P600M power supply modules. The power output of the lamps may be adjusted to account for faster or slower line speeds. The UV lamp time range is 0.5 to 1.5 seconds per foot in various embodiments. Normally the UV lamp time is 10.5 seconds total (5.25 seconds per side direct) and 10.5 seconds per side of travel.

In the exemplary process, the substrate is carried through the equipment performing each step 10, 20, 30 on a conveyor system approximately 200 feet in length. The line speed may range from 5 feet per minute to 15 feet per minute in this exemplary embodiment, and is normally 10 feet per minute. The line speed is dependent upon system design and is independent of processing results. The conveyor of the exemplary process is a vertical hanging line type. It is also within the scope of the invention to utilize a horizontal or other type of conveyor system. Once cured, the embossed and/or etched and coated substrate may be removed from the conveyer line.

In the exemplary process, the UV curable powder material may comprise one or more resins (non-crystalline or crystalline or any combination thereof), a photo initiator, and/or other additives (such as, but not limited to, flow agent, degassing agent, and/or texturizing agent). The powder coating may be capable of being cured by free-radical polymerization through irradiation by electron beam or UV light. Exemplary UV curable resins may contain (meth) acrylic double bonds which react with free radicals to cause the formation of new bonds within the coating, thus creating a cross-linked network.

In an alternative exemplary process, a thermosetting powder coating composition may be used. Such an alternative process may replace or supplement the UV curing lamps with one or more ovens adapted to provide an appropriate heat curing environment. An exemplary low temperature curing thermosetting powder coating composition may comprise one or more resins (non-crystalline or crystalline or any combination thereof), a curing agent, a cure catalyst, and/or other additives (such as, but not limited to, flow agent, degassing agent, and/or texturizing agent). Exemplary curing temperatures may be below 350 F and the cure time requirement may be in the range of 5 to 30 minutes.

Exemplary powder materials may be opaque, semi-opaque, translucent, or transparent and may be colorless or tinted. It is within the scope of the invention to utilize powder that is UV curable, thermally curable, or a combination thereof. Additionally, it is within the scope of the invention to utilize more than one powder material and such powder materials may have different properties.

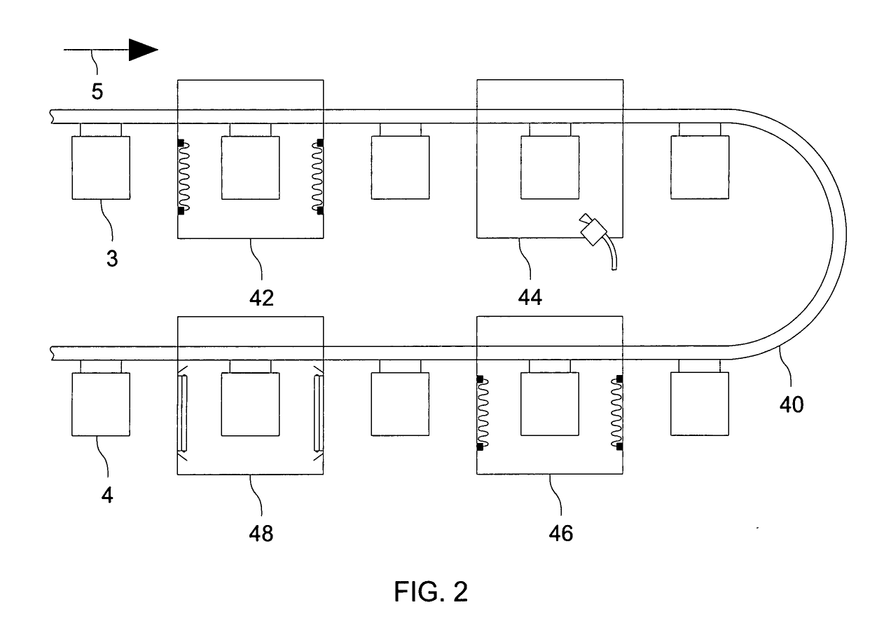

FIG. 2 is a schematic representation of an exemplary process as described above. A laser etched and/or embossed substrate 3 is carried through the process on a conveyor 40 in the direction indicated by arrow 5. The substrate 3 is preheated in oven 42, coated with powder in booth 44, gelled/flowed in oven 46, and the powder coat is cured in the UV light system 48. The finished product, a laser etched and/or embossed and powder coated substrate 4, is then removed from the conveyor 40.

Steps included in the above-described process may be used to produce a laser embossed simulated wood grain finish on a substrate. Such a substrate may comprise MDF. In such a process, a wood grain image may be obtained by scanning, copying, or photographing a sample of a species (for example, but not limited to, ash, oak, pine, walnut, or cherry) of wood with visible grain. The wood grain image may be manipulated and prepared for embossing as described above. Once the substrate is embossed with the wood grain image, it may be powder coated as described above.

Steps included in the above-described process may be used to produce a substrate having an laser etched design, graphic, logo, or other image. Such a substrate may comprise MDF. In such a process, the design, graphic, logo, or other image may be obtained and prepared as described above. Once the design, graphic, logo, or other image is etched onto the substrate, the substrate may be powder coated as described above.

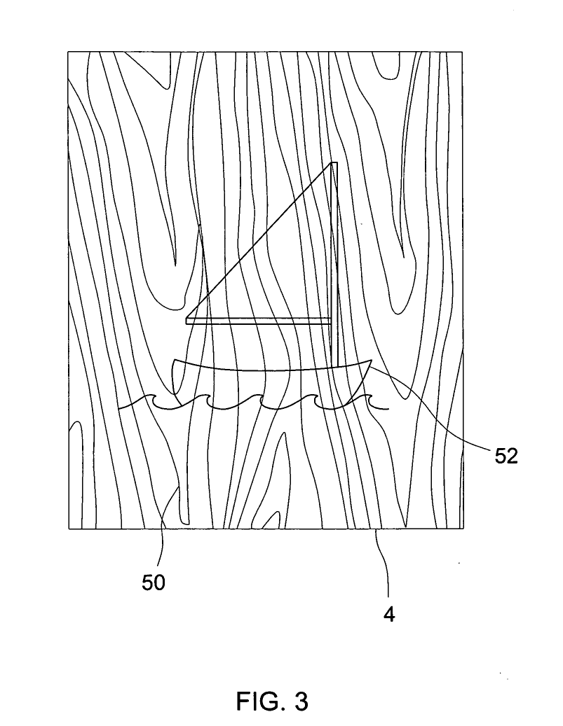

Steps included in the above-described process may be used to produce a substrate 4 having a laser embossed simulated wood grain finish 50 and a laser etched design, graphic, logo, or other image 52 as shown in FIG. 3. Such a substrate 4 may comprise MDF. In such a process, the image preparation steps may be performed concurrently for one or more images or may be performed separately for each image to be embossed and/or etched. Similarly, the embossing and etching steps may be performed concurrently or may be performed sequentially. For example, a wood grain image may be embossed and/or etched first, then a logo may be embossed and/or etched second. In a detailed exemplary process, the laser may be programmed to emboss a wood grain image and then etch a logo image. Once the embossing and/or etching is complete, the substrate 4 may be powder coated as described above.

Products produced by such a process may include MDF having a laser embossed and/or etched simulated wood grain finish. The products may additionally or alternatively include a laser embossed and/or etched logo, graphic, or other image. Such a logo, graphic, or other image may be superimposed on the wood grain finish such that the product appears to be a natural wood board having a logo or graphic carved, embossed, and/or etched thereon.

Products produced by such a process may also include other substrates, such as, but not limited to, plastics, having a laser embossed and/or etched wood grain finish. The products may additionally or alternatively include a laser embossed and/or etched logo, graphic, or other image. Such a logo, graphic, or other image may be superimposed on the wood grain finish such that the product appears to be a natural wood board having a logo or graphic carved, embossed, and/or etched thereon.

While exemplary embodiments of the invention have been set forth above for the purpose of disclosure, modifications of the disclosed embodiments of the invention as well as other embodiments thereof may occur to those skilled in the art. Accordingly, it is to be understood that the inventions contained herein are not limited to the above precise embodiments and that changes may be made without departing from the scope of the invention. Likewise, it is to be understood that it is not necessary to meet any or all of the stated advantages or objects of the invention disclosed herein to fall within the scope of the invention, since inherent and/or unforeseen advantages of the present invention may exist even though they may not have been explicitly discussed herein.

What is claimed is:

1. A method for finishing a substrate, comprising the steps of:
transferring at least a first image onto a substrate using at least one of laser embossing and laser etching;
coating the substrate with a powder coating; and
curing the powder coating.

2. The method of claim 1, further comprising a step of transferring a second image onto the substrate using at least one of laser embossing and laser etching.

3. The method of claim 1, wherein the first image comprises wood grain.

4. The method of claim 1, wherein the first image comprises at least one of a graphic, pattern, design, logo, character, text, likeness, picture, and texture.

5. The method of claim 2, wherein the first image comprises wood grain and the second image comprises at least one of a graphic, design, logo, character, text, likeness, and picture.

6. The method of claim 1, wherein the substrate comprises an engineered wood product.

7. The method of claim 6, wherein the engineered wood product comprises medium density fiberboard.

8. The method of claim 1, wherein the substrate comprises a solid polymer.

9. The method of claim 1, wherein the powder coating is a resin based powder coating that cures to be substantially transparent.

10. The method of claim 9, wherein the powder coating is an ultra-violet light curable powder coat and the curing step uses ultra-violet light to cure the powder coat.

11. The method of claim 9, wherein the powder coat is a thermosetting powder coat composition and the curing step uses heat to cure the powder coat.

12. A method for finishing a substrate, comprising the steps of:
providing a substrate comprising medium density fiberboard;
transferring at least a first image comprising a wood grain onto the substrate using at least one of laser embossing and laser etching;
preheating the substrate;
electro-static powder coating the substrate with a powder coat;
heating the substrate to cause the powder coat to at least one of gel and flow; and
curing the powder coat using ultra-violet light.

13. The method of claim 12, further comprising the step of, prior to the powder coating step:
transferring a second image onto the substrate using at least one of laser embossing and laser etching.

14. The method of claim 13, wherein the second images comprises at least one of a graphic, pattern, design, logo, character, text, likeness, and picture.

15. The method of claim 13, further including the steps of manipulating the first image and manipulating the second image, prior to the transferring steps, wherein the manipulating steps include at least one of cropping, rotating, resizing, or copying.

16. The method of claim 13, wherein the first image and the second image are transferred onto a first surface of the substrate and a second surface of the substrate, respectively.

17. The method of claim 12, wherein the powder coat is a resin based powder coat that cures to be substantially transparent.

18. The method of claim 13, wherein the powder coat is a resin based powder coat that cures to be substantially transparent and tinted.

19. A method for finishing a substrate, comprising the steps of:
providing a substrate comprising medium density fiberboard;
transferring at least a first image comprising a wood grain onto the substrate using at least one of laser embossing and laser etching;
transferring at least a second image comprising at least one of a graphic, pattern, design, logo, character, text, likeness, and picture onto the substrate using at least one of a laser embossing and laser etching;
preheating the substrate;
electro-static powder coating the substrate with a powder coat;
heating the substrate to cause the powder coat to at least one of gel and flow; and
curing the powder coat.

20. The method of claim 19, wherein the curing step is an ultra violet curing step.

21. The method of claim 19, wherein the curing step is a thermal curing step.

22. The method of claim 19, wherein the preheating step uses both infra red energy and convection.

23. The method of claim 19, further comprising the step of conveying the substrate through the preheating, powder coating and curing steps on a conveyor system.

24. The method of claim 19, wherein the curing step is a combination of at least thermal curing and ultra violet curing.

25. A method for finishing a substrate, comprising the steps of:
providing a substrate comprising medium density fiberboard;
transferring at least a first image comprising a wood grain onto the substrate;
preheating the substrate;
electrostatic powder coating the substrate with a powder coat;
heating the substrate to cause the powder coat to at least one of gel and flow; and
curing the powder coat thereby creating a product with a simulated wood grain finish.
